(19) United States
(12) Patent Application Publication
(10) Pub. No.: US 2006/0155064 A1
(43) Pub. Date: Jul. 13, 2006

(54) Polyesters and slurries containing microfiber and micropowder, and methods for using and making same

(76) Inventor: Steven M. Hansen, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/032,575

(22) Filed: Jan. 10, 2005

(51) Int. Cl. C08L 5/00; C08L 67/02

(52) U.S. Cl. 525/165; 524/27

(57) ABSTRACT

Polyester compositions comprising microfibers and micropowders are disclosed. The polyester compositions are made by contacting microfibers and micropowders with polymerizable components, such as monomers, suitable for making polyesters, and polymerizing the polymerizable components. The microfibers and micropowders can be provided in the form of either separate slurries, or a single slurry. The micropowders can also alternatively be provided in the form of a powder rather than a slurry. A slurry containing microfiber and micropowders, and a process for making such a slurry, is also disclosed. Incorporating microfibers and micropowders into a polyester improves the properties of the molded parts, films and/or fibers that are made from such a polyester. A slurry containing microfibers and micropowders is more stable and easier to process, wherein the micropowder is less likely to separate out of the slurry or agglomerate when compared to a slurry containing only micropowder.

### FIELD OF THE INVENTION

The present invention is directed to a polyester composition containing polyester, at least one microfiber and at least one micropowder, and to methods for making and using the polyester composition. The present invention is also directed to a slurry containing a liquid medium, at least one microfiber and at least one micropowder, and to a process for making such a slurry.

### BACKGROUND OF THE INVENTION

Thermoplastic polyester resins, such as polyethylene terephthalate and polybutylene terephthalate, have excellent mechanical properties, chemical resistance and dimensional stability, and are widely used in applications, such as injection molding, textile and monofilament fibers, and films.

It is well known that thermoplastic resins, including thermoplastic polyesters, can be modified by having fibers and/or particulate additives incorporated therein. For example, it is known that a fiber and/or particulate additive can be incorporated as filler into a thermoplastic polymer to lower the overall costs of the thermoplastic resin. It is also known that the mechanical properties and/or chemical resistance of a thermoplastic resin can be modified and/or improved by incorporating a particulate additive into a thermoplastic polymer.

For example, it is known that particulate additives, such as fluoropolymer micropowders can be added to thermoplastic polymers that are used to produce industrial textiles, such as, for example, textile articles used in filtration and dewatering processes; carpeting; fabrics for sportswear and outerwear; hot-air balloons; car and plane seats; and umbrellas. It is further known that incorporating fluoropolymer micropowders, such as polytetrafluoroethylene (PTFE) into such polymers can produce textiles having certain advantages, e.g. textiles that are easier to clean, fibers having improved tensile strength, etc.

It is also known that fibers can be added to thermoplastic polymers to make composites, including advanced engineering composites, wherein the properties of the thermoplastic resin are significantly modified by the reinforcing effect of the fibers. Advanced engineering composites having polyamide fibers, such as either Kevlar® fibers, or carbon fiber incorporated into the thermoplastic polyester matrix of the resin are known and widely used in articles, such as, for example, sporting goods.

Recently, research has been conducted to learn how finely divided additives with particle sizes on the order of nanometers can be used to modify material properties. For example, U.S. Pat. No. 6,020,419 discloses how relatively small amounts of a modifier can affect properties, such as, for example, scratch resistance and electrical properties.

A need remains, however, for improved polymeric materials that can withstand melt processing while maintaining structural properties, and also for polymeric materials having abrasion resistance when used in applications such as films. A further need remains for polymeric materials having improved properties such as adhesion.

### SUMMARY OF THE INVENTION

One aspect of the invention is a polyester composition comprising polyester, at least one microfiber and at least one micropowder.

In some preferred embodiments, the polyester composition comprises polyesters, from about 0.01 to about 15 wt. % microfiber and from about 0.5 to about 50 wt. % micropowder, based on the total weight of the polyester composition. In some embodiments, the polyester is a homopolymer. In some embodiments, the polyester is a copolymer. In some preferred embodiments, the polyester is polyethylene terephthalate. In other preferred embodiments, the polyester is a copolyester comprising ethylene terephthalate and at least one comonomer. In some preferred embodiments, the microfiber is organic. In other preferred embodiments, the micropowder is a PTFE.

Another aspect of the invention is a process for making a polyester composition comprising a polyester, at least one microfiber, and at least one micropowder. The process includes providing the at least one microfiber in a form selected from a slurry; providing the at least one micropowder in a form selected from a powder and a slurry; contacting the at least one microfiber and the at least one micropowder with at least one polymerizable component of the polyester; and polymerizing the polymerizable components. In some embodiments, the at least one polymerizable component comprises monomers. In other embodiments, the at least one microfiber and at least one micropowder are provided in a slurry containing both the at least microfiber and the at least one micropowder.

Another aspect of the invention is a slurry comprising at least one microfiber, at least one micropowder, and at least one liquid medium, and a process for producing such a slurry.

Another aspect of the invention is a monofilament made from a polyester composition comprising a polyester; from about 0.01 to about 15 wt. % microfiber; and from about 0.5 to about 50 wt. % micropowder, based on total weight of the polyester composition.

A further aspect of the invention is a molded part made from a polyester composition comprising polyester; from about 0.01 to about 15 wt. % microfiber; and from about 0.5 to about 50 wt. % micropowder, based on total weight of the polyester composition.

A further aspect of the invention is a cast film made from a polyester composition comprising polyester; from about 0.01 to about 15 wt. % microfiber; and from about 0.5 to about 50 wt. % micropowder, based on total weight of the polyester composition. In some embodiments, the film is either uniaxially, or biaxially oriented.

These and other aspects of the invention will be apparent to those skilled in the art upon reviewing the following disclosure and appended claims.

### BRIEF DESCRIPTION OF THE DRAWINGS

FIG. 1 is a graph illustrating the micropowder particle size distribution of various micropowder containing mixtures.

### DETAILED DESCRIPTION OF THE INVENTION

The features and advantages of the present invention will be more readily understood by those of ordinary skill in the art upon reading the following detailed description. It is to be appreciated that certain features of the invention that are, for clarity reasons, described above and below in the context of separate embodiments, may also be combined to form a single embodiment. Conversely, various features of the invention that are, for brevity reasons, described in the context of a single embodiment, may be combined so as to form sub-combinations thereof.

Moreover, unless specifically stated otherwise herein, references made in the singular may also include the plural (for example, “a” and “an” may refer to either one, or one or more). In addition, unless specifically stated otherwise herein, the minimum and maximum values of any of the variously stated numerical ranges used herein are only approximations that are understood to be preceded by the word “about” so that slight variations above and below the stated ranges can be used to achieve substantially the same results as those values within the stated ranges. Moreover, each of the variously stated ranges are intended to be continuous so as to include every value between the stated minimum and maximum value of each of the ranges.

Further, when an amount, concentration, or other value or parameter is given as a list of upper preferable values and lower preferable values, this is to be understood as specifically disclosing all ranges formed from any pair of an upper preferred value and a lower preferred value, regardless of whether ranges are separately disclosed.

All patents, patent applications and publications referred to herein are incorporated by reference.

The present invention provides polyester compositions containing polyesters, microfibers and micropowders. Such polyester compositions offer improved melt processing, and produce polymers having improved abrasion in comparison to conventional polyester polymers that do not contain microfibers and micropowders.

The present invention also provides processes for making polyester compositions containing polyesters, microfibers and micropowders. The processes provide improved dispersion of the microfibers and micropowders in the polyesters, such that the particles dispersed therein are well separated and do not reagglomerate.

The present invention also provides a slurry containing the at least one microfiber and the at least one micropowder. Such a slurry has been found to be more stable and easier to process than separate slurries of either component. A slurry containing at least one micropowder and at least one microfiber is more stable against the micropowder separating out of the dispersed solids when compared to a slurry that only contains micropowder. In addition, such a slurry has been found to effectively reduce agglomeration of the micropowder in comparison to a slurry that only contains micropowder.

While it is not intended that the present invention be bound by any particular theory, it is believed that some of the observed improved properties of the microfiber and micropowder containing polyester compositions, and polyester polymers produced therefrom, as well as, the improved dispersion of microfibers and micropowders in the polyester of such polyester compositions, are due in part to an interaction between functional groups on the polyesters and functional groups on the microfibers and micropowders. In addition, it is believed that at least some of the improved properties of the microfiber and micropowder containing slurry are due at least in part to the physical interaction of particles of dissimilar shape.

The term “polyester composition” is used herein to refer to compositions including a polyester, microfibers, micropowders and any optional additives and/or processing aids that can be present.

The term “microfiber(s)” as used herein refers to a “processed organic fiber” that can generally be described as fiber because of its aspect ratios. The microfibers preferably contained in the slurries of the present invention, as disclosed herein, have aspect ratios ranging from about 10:1 to about 500:1, and more preferably from about 25:1 to about 300:1. For example, some preferred fibers have volume average lengths of from about 0.01 to about 100 microns and diameters of from about 8 to 12 microns. Generally, the microfibers have an average surface area ranging from 25 to 500 m²/gram. These dimensions, however, are only approximations. Moreover, the use of the term “diameter” is not intended to indicate that the microfibers have to be cylindrical in shape or circular in cross-section.

The term “processed organic fiber” is used herein to refer to “organic fiber” that has been contacted with a medium comprising a liquid component and a solid component, and then agitated to size reduce and modify the organic fiber.

The term “organic fiber” is used herein to refer to pulp, short fiber or fibrids.

The microfibers may also be referred to as “nanofibers”, which is an indication that in at least one dimension, the size of the particulate materials is on the order of nanometers. Microfibers, particularly when in the form of a slurry or dispersion, may also be referred to as either “micropulp”, or as “nanopulp”. The term “microfibers” is used herein to refer to the processed fibers whether or not the fibers are contained in a slurry.

The term “micropowder(s)” is used herein to refer to finely divided, easily dispersed polymers having powders or particles with an average diameter ranging from about 0.01 to about 100 microns. An average diameter of about 5 microns or less, however, is preferred. The micropowders are ordinarily polymeric materials that are preferably hydrophobic and inert.

The microfibers of the present invention include, but are not limited to organic and/or inorganic microfibers. The organic microfibers can contain any known organic material used to make organic fibers. Examples of the materials from which organic fibers can be made include, but are not limited to, synthetic polymers, such as aliphatic polyamides, polyesters, polyacrylonitriles, polyvinyl alcohols, polyolefins, polyvinyl chlorides, polyvinylidene chlorides, polyurethanes, polyfluorocarbons, phenolics, polybenzimidazoles, polyphenylenetriazoles, polyphenylene sulfides, polyoxadiazoles, polyimides, and/or aromatic polyamides; natural fibers, such as cellulose, cotton, silk, and/or wool fibers; and mixtures thereof.

Some commercially available organic fibers that can be used to produce the organic microfibers of the present invention included, but are not limited to, ZYLON® PBO-AS (poly(p-phenylene-2,6-benzobisoxazole)) fiber, ZYLON® PBO-HM (poly(p-phenylene-2,6-benzobisoxazole)) fiber, and DYNEEMA® SK60 and SK71 ultra high strength polyethylene fiber, which are available from Toyobo, Japan; Celanese VECTRAN® HS pulp and EFT 1063-178, which are available from Engineering Fibers Technology, Shelton, Conn.; CFF Fibrillated Acrylic Fiber, which is available from Sterling Fibers, Inc., Pace, Fla.; and Tiara Aramid KY-400S Pulp, which is available from Daicel Chemical Industries, Ltd., 1 Teppo-Cho, Sakai City, Japan.

In some applications, the organic fibers are preferably made of aromatic polyamide polymers, especially poly(p-phenylene terephthalamide) and/or poly(m-phenylene isophthalamide), which are also known as aramid fibers. As used herein, an “aramid” is a polyamide having amide (—CONH—) linkages of which at least 85% are attached directly to two aromatic rings.

The organic fibers that can be used to make the microfibers of the present invention can also contain known additives. For example, the aramid fibers can have one or more other polymeric materials blended with the aramid. Specifically, the aramid fibers can contain up to about 10%, by weight, of other polymeric materials. If desired, copolymers of the aramid can have either as much as 10% of one or more other diamine substituted for the diamine of the aramid, or as much as 10% of other diacid chloride substituted for the diacid chloride of the aramid. Such organic fibers are disclosed in U.S. Pat. Nos. 3,869,430; 3,869,429; 3,767,756; and 2,999,788.

Preferably, the aromatic polyamide organic fibers used in accordance with the present invention are commercially available as KEVLAR®; KEVLAR® aramid pulp, style 1F543; 1.5 millimeter (mm) KEVLAR® aramid floc style 6F561; and NOMEX® aramid fibrids style F25W, all available from E. I. du Pont de Nemours and Company, Wilmington, Del.

The inorganic fibers that can be used to make the microfibers of the present invention include, but are not limited to, fibers made of alumina; glass; carbon fibers; carbon nanotubes; silica carbide fibers; mineral fibers made of, for example, wollastonite (CaSiO₃); and whiskers, which are single crystals of materials, such as, for example, silicon carbide, boron, and boron carbide, and are more fully described in Plastics Additives, 3rd, Gachter and Muller, Hanser Publishers, New York, 1990.

Micropowders suitable for use in accordance with the present invention include, but are not limited to, those based on the group of polymers known as tetrafluoroethylene (TFE) polymers. This group includes, but is not limited to PTFE homopolymers and PTFE copolymers, wherein the homopolymers and copolymers each individually contain small concentrations of at least one copolymerizable modifying monomer such that the resins remain non-melt-fabricable (modified PTFE).

The modifying monomer can be, for example, hexafluoropropylene (HFP), perfluoro(propyl vinyl) ether (PPVE), perfluorobutyl ethylene, chlorotrifluoroethylene, or another monomer that introduces side groups into the polymer molecule. The concentration of such copolymerized modifiers in the polymer is usually less than 1 mole percent. The PTFE and modified PTFE resins that can be used in this invention include those derived from suspension polymerization, as well as, those derived from emulsion polymerization.

Micropowders suitable for use in accordance with the present invention also include, but are not limited to, those based on powdered organic polymers and pulverized minerals, wherein variously available grinding devices, such as, for example, a mill or a grinder can be used to reduce the powdered organic polymers and pulverized minerals into finely divided powders. The variously available grinding devices suitable for such use are well known to a person of ordinary skill in the art.

Preferably the micropowder is a fluoropolymer. More preferably, the micropowder is a TFE polymer. Most preferably, the micropowder is a PTFE powder, such as Zonyl® MP 1600 available from E. I. du Pont de Nemours and Company, Wilmington, Del., and has an average particle diameter of about 0.2 microns.

In producing the slurries of the present invention, either organic and/or inorganic fiber starting materials, or a microfiber containing slurry can be used.

If organic and/or inorganic fiber starting materials are provided, the amount of organic and/or inorganic fiber starting material(s) preferably ranges from about 0.01 to about 50 wt. %, based on total weight of the resulting slurry containing both microfiber and micropowder, more preferably from about 0.10 to about 25 wt. %, and most preferably from about 1 to about 10 wt. %. The organic and/or inorganic fiber starting material(s) can be combined with the micropowder and the liquid medium using conventional mixing and pumping equipment.

If a microfiber slurry is provided, the microfiber slurry preferably contains at least about 0.01 wt. % microfiber, based on total weight of the slurry. The microfiber slurry, however, can contain up to about 25 or 50 wt. % microfiber, based on total weight of the slurry, wherein the practical upper limit of the amount of microfiber in the slurry is determined by handling and equipment requirements. More preferably, the slurry contains at least about 0.1 wt. % microfibers, based on total weight of the slurry. The slurry preferably contains about 15 wt. % or less microfiber, based on total weight of the slurry, more preferably about 10 wt. % or less, and even more preferably, about 5 wt. % or less. In some preferred embodiments, the slurry contains from about 0.01 to about 50 wt. % microfibers, based on total weight of the slurry, preferably from about 0.1 to about 15 wt. % microfibers, more preferably from about 0.1 to about 10 wt. %, even more preferably from about 0.1 to about 5 wt. %, most preferably from about 0.1 to about 2.5 wt. %, and even most preferably from about 0.2 to about 1 wt. %. The slurry can be combined with the micropowder and liquid medium using conventional mixing and pumping equipment.

The microfiber slurry can be made from a variety of starting materials such as, for example, organic fibers, inorganic fibers, or mixtures derived therefrom. The starting materials are subsequently processed into microfibers by contacting the starting material with a liquid medium followed by agitating the starting material and liquid medium in an agitiating device so as to reduce the size of and/or modify the starting material. The agitation can typically be accomplished, for example, by refining the starting material between rotating discs so as to cut and shear the starting material into smaller pieces. The processing of the starting material into microfibers will preferably result in the microfibers being substantially uniformly dispersed in the liquid medium. Processed starting materials differ from short fibers by having a multitude of fibrils extending from the body of each fiber particle. The fibrils provide minute hair-like anchors that can reinforce composite materials and can cause the processed starting materials to have very high surface areas.

Optionally, the starting materials and liquid medium can be combined with a solid component, which may aid in reducing the starting material to microfibers, and agitated in an agitating device. If desired, the starting materials and liquid medium can first be combined to form a premix. The premix can then be mixed in a conventional mixer to distribute the starting materials in the liquid medium. The premix can subsequently be combined with the solid component and agitated in the agitating device. After being agitated for an effective amount of time to produce a microfiber slurry containing microfibers having the desired size, the solid component is removed.

Generally, the solid component is first placed in the agitation chamber of the agitating device and the other ingredients added thereto. The order of addition, however, is not critical. For example, the liquid medium and solid component can be combined and added to the agitating device before the starting materials added thereto or the starting materials and solid component can be combined and added to the agitating device before the liquid medium is added thereto. Likewise, the solid component, liquid medium, and starting materials can be combined and then added to the agitating device.

During agitation, the starting materials repeatedly come into contact with, and are masticated by, the optional solid component. A person of ordinary skill in the art is familiar with the types of agitating devices that can be used in accordance with the process of the invention, such as for example, an attritor or a mill. Preferably, however, an attritor is used.

The agitating devices can be batch or continuously operated. Batch attritors are well known in the art, wherein suitable attritors include Model Nos. 01, 1-S, 10-S, 15-S, 30-S, 100-S and 200-S supplied by Union Process, Inc. of Akron, Ohio. Another supplier of such devices is Glen Mills Inc. of Clifton, N.J. Suitable media mills include the Supermill HM and EHP models supplied by Premier Mills of Reading, Pa.

When an attritor is used, the agitation of the solid component is generally controlled by the tip speed of the stirring arms and the number of stirring arms provided. A typical attritor has four to twelve arms and the tip speeds of the stirring arms generally range from about 150 fpm to about 1200 fpm (about 45 meters/minute to about 366 meters/minute). The preferred attritor has six arms and is operated at tip speeds in the range of from about 200 fpm to about 1000 fpm (about 61 meters/minute to about 305 meters/minute), and more preferably from about 300 fpm to about 500 fpm (about 91 meters/minute to about 152 meters/minute).

When a media mill is used, the agitation of the solid component is generally controlled by the tip speed of the stirring arms or disks and the number of stirring arms/disks provided. A typical media mill has 4 to 10 arms/disks and the tip speed of the stirring arms/disks generally ranges from about 1500 fpm to about 3500 fpm (about 457 meters/minute to about 1067 meters/minute), and preferably from about 2000 fpm to about 3000 fpm (about 610 meters/minute to about 914 meters/minute).

Any excessive heat that is generated during agitation can normally be removed by using a cooling jacket on the agitation chamber.

The amount of solid component used in the agitating chamber is called the “load”, and is measured by the bulk volume and not the actual volume of the agitating chamber. For example, a 100% load will only occupy about 60% of the chamber volume because the solid component contains substantial air pockets. The load added to the agitating chamber of a media mill or an attritor ranges from about 40% to about 90%, and preferably from about 75% to about 90%, based on full load. The load for a ball mill ranges from about 30% to about 60%, based on the full load. In practice, percent load is determined by first filling the agitating chamber with solid component to determine the weight of a full load, and then identifying the weight of the desired load as a percent of the full load.

Conventional mixers that can be used in preparing the optional premix include, for example, stirred tank mixers.

A process for preparing a slurry of microfibers suitable for incorporation into a polyester is described in co-owned patent application Ser. No. 10/428,294 entitled “Polymer Precursor Dispersion Containing a Micropulp and Method of Making the Dispersion”, the disclosure of which is hereby incorporated herein by reference.

A particularly useful starting material is aramid pulp, which is well known in the art and can be made by refining aramid fibers to fibrillate the short pieces of aramid fiber material. Such pulps have been reported to have a surface area in the range of 4.2 to 15 m²/g, and a Kajaani weight average length in the range of 0.6 to 1.1 millimeters (mm). Such pulps have high volume average length in comparison to a micropulp. For example, Style 1F543 aramid pulp available from E. I. du Pont de Nemours and Company has a Kajaani weight average length in the range of 0.6 to 0.8 mm, and, when laser defraction is used to measure the pulp, a volume average length of about 0.5 to 0.6 mm. An alternate method of making aramid pulp directly from a polymerizing solution is disclosed in U.S. Pat. No. 5,028,372.

Short fiber (sometimes called floc) is made by cutting continuous filament into short lengths without significantly fibrillating the fiber. Short fiber length typically ranges from about 0.25 mm to 12 mm. Short fibers suitable for use in polyesters are the reinforcing fibers disclosed in U.S. Pat. No. 5,474,842.

Fibrids are non-granular film-like particles having an average maximum length or dimension in the range of 0.2 to 1 mm with a length-to-width aspect ratio in the range of 5:1 to 10:1. The thickness dimension is on the order of a fraction of a micron. Aramid fibrids are well known in the art and can be made in accordance with the processes disclosed in U.S. Pat. Nos. 5,209,877; 5,026,456; 3,018,091; and 2,999,788. The processes typically include adding a solution of organic polymer in solvent to another liquid that is a non-solvent for the polymer but is miscible with the solvent, and applying vigorous agitation to cause the fibrids to coagulate. The coagulated fibrids are wet milled, separated, and dried to yield clumps of fibrids having a high surface area; the clumps are then opened to yield a particulate fibrid product.

Preferably, the liquid medium of the microfiber slurry includes, but is not limited to, aqueous and non-aqueous solvents; monomers; and polymer precursors. A person of ordinary skill in the art, however, is familiar with other acceptable liquid medium. Suitable polymer precursors are disclosed in co-owned patent application Ser. No. 10/428,294 entitled “Polymer Precursor Dispersion Containing a Micropulp and Method of Making the Dispersion”, already incorporated herein by reference. Preferably, the polymer precursor is ethylene glycol.

The amount of liquid medium needed generally depends on the amount of slurry and the microfiber weight percent of the slurry being produced. That is, the amount of microfiber slurry needed and the desired microfiber weight percent of the microfiber slurry being produced will dictate how much liquid medium needs to be added to the microfiber slurry that is being produced. A person of ordinary skill in the art is familiar with how to determine the amount of liquid medium needed to produce the desired amount of microfiber slurry having the desired microfiber weight percent.

The optional solid component preferably has a spheroidal shape. The shape of the solid component, however, is not critical, and includes, but is not limited to, spheroids; diagonals; irregularly shaped particles; and combinations thereof. The maximum average size of the solid component depends on the type of agitating device being used. In general, however, the maximum average size of the solid component ranges from about 0.01 mm to about 127 mm in diameter.

For example, when attritors are used, the size generally varies from about 0.6 mm to about 25.4 mm in diameter. When media mills are used, the diameter generally varies from about 0.1 to 2.0 mm, preferably from 0.2 to 2.0 mm. When ball mills are used, the diameter generally varies from about 3.2 mm (⅛″) to 76.2 mm (3.0 inches), preferably from 3.2 mm (⅛″) to 9.5 mm (⅜ inches).

The solid component is generally chemically compatible with the liquid component and is typically made of materials including, but not limited to, glass; alumina; zirconium oxide; zirconium silicate; cerium-stabilized zirconium oxide; fused zirconia silica; steel; stainless steel; sand; tungsten carbide; silicon nitride; silicon carbide; agate; mullite; flint; vitrified silica; borane nitrate; ceramics; chrome steel; carbon steel; cast stainless steel; plastic resin; and combinations thereof. The plastic resins suitable for making the solid component include, but are not limited to, polystyrene; polycarbonate; and polyamide. The glass suitable for the solid component includes, but is not limited to, lead-free soda lime; borosilicate; and black glass. Zirconium silicate can be fused or sintered.

The most useful solid components are balls made of carbon steel; stainless steel; tungsten carbide; or ceramic. If desired, a mixture of balls having either the same or different sizes and being made of either the same or different materials can be used. Ball diameter can range from about 0.1 mm to 76.2 mm and preferably from about 0.4 mm to 9.5 mm, more preferably from about 0.7 mm to 3.18 mm. Solid components are readily available from various sources, some of which include Glenn Mills, Inc., Clifton, N.J.; Fox Industries, Inc., Fairfield, N.J.; and Union Process, Akron, Ohio.

In producing the slurries of the present invention, the micropowder can be added either as a dry powder, or as a micropowder containing slurry.

If a dry powder is used, the amount of dry powder added preferably ranges from about 0.5 to about 50 wt. %, based on total weight of the resulting polyester composition, more preferably from about 1 to about 25 wt. %, and most preferably from about 2 to about 15 wt. %. The dry powder can be combined with either the organic and/or inorganic fibers or microfiber slurry and the liquid medium using conventional mixing and pumping equipment.

If a slurry is used, the micropowder slurry preferably contains at least about 0.5 wt. % micropowder, based on total weight of the slurry. The micropowder slurry, however, can contain up to about 50 wt. % micropowder, based on total weight of the slurry, wherein the practical upper limit of the amount of micropowder in the slurry is determined by slurry viscosity and material handling capabilities. More preferably, the slurry contains at least about 1 wt. % micropowder, based on total weight of the slurry, and even more preferably at least about 2 wt. % micropowder. Also, the slurry preferably contains about 25 wt. % or less micropowder, based on total weight of the slurry, more preferably about 20 wt. % or less micropowder, and even more preferably about 10 wt. % or less micropowder. In some preferred embodiments, the slurry contains from about 0.5 wt. % to about 50 wt. % micropowder, based on total weight of the slurry, preferably from about 1 wt. % to about 25 wt. %, even more preferably from about 1 wt. % to about 20 wt. %, and most preferably from about 1 to about 10 wt. %. The slurry can be combined with either the organic and/or inorganic fibers or microfiber slurry and the liquid medium using conventional mixing and pumping equipment.

The micropowder slurry is generally prepared by the same methods as described hereinabove for preparing a slurry only containing microfibers. That is, in general the micropowder is contacted with a liquid medium and optional solid component followed by agitating the micropowder, liquid medium and optional solid component in a mill, such as a ball mill to substantially uniformly disperse the micropowder in the liquid medium. A person of ordinary skill in the art, however, is familiar with other acceptable processes for preparing a micropowder slurry. For example, the micropowder and liquid medium can first be combined to form a premix. The premix can then be mixed in a conventional mixer to distribute the micropowder in the liquid medium, and then subsequently combined with the solid component and agitated in the agitating device. After being agitated for an effective amount of time to produce a micropowder slurry containing micropowders having the desired size and uniform distribution, the solid component is removed.

Like the process used to prepare the microfiber slurry, the order in which the micropowder, solid component and liquid medium are combined is not critical. In addition, the same conventional mixers, solid components, liquid medium and agitating devices used to prepare the microfiber slurry can be used to prepare the micropowder slurry. In addition, the same methods used to determine the amount of liquid medium to add to the microfiber slurry can be used to determine how much liquid medium to add to the micropowder slurry.

A slurry containing both micropowder and microfibers preferably contains at least about 0.01 wt. % microfiber and at least about 0.5 wt. % micropowder, based on total weight of the slurry. This slurry, however, can contain up to about 15 wt. % microfibers and up to about 50 wt. % micropowder, based on total weight of the slurry, wherein the practical upper limit of the amount of microfibers and micropowders in the slurry is determined by viscosity and material handling. More preferably, the slurry contains at least about 0.2 wt. % microfiber and at least about 2 wt. % micropowder, based on total weight of the slurry. The slurry preferably contains about 15 wt. % or less microfibers and about 30 wt. % or less micropowder, based on total weight of the slurry; more preferably about 10 wt. % or less microfibers and about 25 wt. % or less micropowder; and even more preferably about 5 wt. % or less microfibers and 20 wt. % or less micropowder. The slurry can be incorporated into the polyester using conventional mixing and pumping equipment.

In some preferred embodiments, the slurry contains from about 0.01 to about 15 wt. % microfibers and from about 0.5 to about 50 wt. % micropowder, based on total weight of the slurry; preferably from about 0.2 to about 15 wt. % microfiber and from about 1 to about 30 wt. % micropowder; more preferably from about 0.2 to about 10 wt. % microfiber and from about 2 to about 25 wt. % micropowder; even more preferably from about 0.2 to about 5 wt. % microfiber and from about 2 to about 20 wt. % micropowder; and most preferably from about 0.2 to about 2.5 wt. % microfiber and from about 5 to about 20 wt. % micropowder.

A slurry containing both micropowder and microfibers is generally prepared by the same methods as described hereinabove for preparing the microfiber slurry or micropowder slurry. The micropowders, however, are preferably added before agitation and size reduction are started. Specifically, processing can be accomplished by contacting the starting materials or microfiber slurry and the at least one micropowder with a liquid medium and optionally a solid component. The contacting step is followed by agitating the starting materials or microfiber slurry, the at least one micropowder, the liquid medium, and the optional solid component so as to reduce the size of and/or modify the starting materials and micropowders.

The micropowder can be provided as a dry powder or micropowder slurry, and the microfibers can be provided as either organic and/or inorganic fiber starting materials, or a microfiber slurry.

Preferably, the microfiber slurry, micropowder, and liquid medium are added to a conventional mixer and premixed to uniformly distribute the microfibers and micropowders in the liquid medium.

Like the process used to prepare the microfiber slurry and the micropowder slurry, the same conventional mixers, solid components, liquid medium, starting materials, micropowder, and agitating devices can be used to prepare the microfiber and micropowder slurry. In addition, the same methods used to determine the amount of liquid medium to add to the microfiber or micropowder containing slurries can be used to determine how much liquid medium to add to the micropowder and microfiber slurry.

During agitation, the starting materials and micropowders repeatedly come into contact with, and are masticated by, the optional solid component.

A person of ordinary skill in the art is familiar with the types of agitating devices that can be used in accordance with the process of the present invention, such as for example, an attritor or a media mill.

The agitating devices can be batch or continuously operated. Batch attritors are well known. Suitable attritors include Model Nos. 01, 1-S, 10-S, 15-S, 30-S, 100-S and 200-S supplied by Union Process, Inc. of Akron, Ohio. Another supplier of such devices is Glen Mills Inc. of Clifton, N.J. Suitable media mills include the Supermill HM and EHP models supplied by Premier Mills of Reading, Pa.

When an attritor is used to prepare the microfiber and micropowder slurry, the solid component is preferably poured into the agitation chamber of the attritor and then agitated by at least one stirring arm of the attritor. The premix can be subsequently poured into the agitation chamber or the liquid media, starting materials or microfiber slurry, and at least one micropowder can be subsequently poured into the agitation chamber. The solid component is maintained in an agitated state by, for example, the at least one stirring arm of the attritor.

When a media mill is used to in preparing the microfiber and micropowder containing slurry, the fiber or microfiber, micropowder, and liquid medium are preferably premixed in the stirred tank mixer and then pumped into the agitation chamber of the media mill. Prior to pumping the premix into the agitation chamber, the solid component is added to the agitation chamber. The premix and solid component are subsequently agitated by at least one stirring arm/disk of the mill. The solid component is maintained in an agitated state by, for example, the at least one stirring arm of the mill.

Unlike the conventional grinding or chopping processes that tend to largely reduce only fiber length, albeit with some increase in surface area and fibrillation, the fiber or microfiber size reduction in of the process of the present invention results from both longitudinal separation of the organic and/or inorganic fibers/microfibers into substantially smaller diameter fibers along with a reduction in the length of the fibers. On average, fiber length and/or diameter reductions of one, two or even greater orders of magnitude can be attained with organic and/or inorganic fiber starting material(s).

The agitating step is continued for an effective amount of time to produce a slurry containing substantially uniformly dispersed microfibers and micropowders having the desired particle sizes and particle size distribution. It may be desirable to incrementally produce the microfiber and micropowder containing slurry by repeatedly passing the liquid medium containing the optional solid component, starting materials or microfiber slurry, and at least one micropowder through the agitation device.

When the optional solid component is used, the surface of the microfiber is fully wetted and uniformly distributed/dispersed in the slurry with minimal agglomerations or clumps. Likewise, the at least one micropowder is uniformly distributed/dispersed in the slurry with minimal agglomerations or clumps.

When a vertical media mill is used, the rate at which the microfiber and micropowder containing slurry is produced can be accelerated by circulating the solid component during the agitating step through an external passage that is typically connected near the bottom and top of the chamber of the vertical media mill. The rate at which the solid component is agitated depends upon the physical and chemical make-up of the starting material being used, the size and type of the solid component, the length of time desired to produce an acceptable slurry, and the size of the microfibers desired in the end slurry.

Upon obtaining a satisfactory microfiber and micropowder containing slurry, the solid component is normally removed from the slurry. Typically, the solid component remains in the agitation chamber. Some conventional separation processes, however, include a mesh screen that has openings small enough for the microfiber and micropowder containing slurry to pass through, while preventing the solid component from passing through. After removing the solid component, the microfiber and micropowder slurry can be used directly. Typically, the slurry will only contain negligible grit or seed that can be visually observed.

Polyesters suitable for use in accordance with the present invention include, but are not limited to, homopolymer polyesters, such as polypropylene terephthalate, polyethylene naphthalate, polybutylene terephthalate, and polycyclohexane terephthalate; and copolyesters. Preferred polyesters are polyethylene terephthalate and copolymers of polyethylene terephthalate; and comonomers, such as dimethyl isophthalate, dimethyl naphthalate, diethylene glycol, propanediol, butanediol, cyclohexane dimethanol, and dimethyl cyclohexanedicarboxylate.

The amount of polyester used in accordance with the present invention depends on the amount of polyester composition having the desired microfiber and micropowder weight percents one desires to produce. That is, the desired amount of polyester composition having the desired micropowder and microfiber weight percents dictates how much polyester needs to be incorporated in the process used to make such polyester composition. A person of ordinary skill in the art is familiar with how to determine how much polyester needs to be used to produce the desired amount of polyester composition having the desired microfiber and/or micropowder weight percents.

The polyester compositions of the present invention can be blended with other polymeric materials. Examples of blendable polymeric materials include, but are not limited to, polyethylene; high density polyethylene; low density polyethylene; linear low density polyethylene; ultra low density polyethylene; polyolefins; poly(ethylene-co-glycidylmethacrylate); poly(ethylene-co-methyl (meth)acrylate-co-glycidyl acrylate); poly(ethylene-co-n-butyl acrylate-co-glycidyl acrylate); poly(ethylene-co-methyl acrylate); poly(ethylene-co-ethyl acrylate); poly(ethylene-co-butyl acrylate); poly(ethylene-co-(meth)acrylic acid); metal salts of poly(ethylene-co-(meth)acrylic acid); poly((meth)acrylates), such as poly(methyl methacrylate), poly(ethyl methacrylate), and the like; poly(ethylene-co-carbon monoxide); poly(vinyl acetate); poly(ethylene-co-vinyl acetate); poly(vinyl alcohol); poly(ethylene-co-vinyl alcohol); polypropylene; polybutylene; polyesters; poly(ethylene terephthalate); poly(1,3-propylene terephthalate); poly(1,4-butylene terephthalate); glycol-modified polyethylene terephthalate (PETG); poly(ethylene-co-1,4-cyclohexanedimethanol terephthalate); polyetheresters; poly(vinyl chloride); Polyvinylidene chloride-vinyl chloride copolymer (PVDC); poly(vinylidene chloride); polystyrene; syndiotactic polystyrene; poly(4-hydroxystyrene); novalacs; poly(cresols); polyamides; nylon; nylon 6; nylon 46; nylon 66; nylon 612; polycarbonates; poly(bisphenol A carbonate); polysulfides; poly(phenylene sulfide); polyethers; poly(2,6-dimethylphenylene oxide); polysulfones; copolymers of ethylene with alkyl(meth)acrylates, such as the Elvaloy® polymers available from E.I. du Pont and Company of Wilmington, Del.; sulfonated aliphatic-aromatic copolyesters, such as are sold under the Biomax® tradename by E. I. du Pont and Company of Wilmington, Del.; aliphatic-aromatic copolyesters, such as are sold under the Eastar Bio® tradename by the Eastman Chemical Company (Eastar Bio® is chemically believed to be essentially poly(1,4-butylene adipate-co-terephthalate (55:45 molar)), under the Ecoflex® tradename by the BASF Corporation (Ecoflex® is believed to be essentially poly(1,4-butylene terephthalate-co-adipate (50:50 molar)) and may be chain-extended through the addition of hexamethylenediisocyanate), and under the EnPol® tradename by the Ire Chemical Company; aliphatic polyesters, such as poly(1,4-butylene succinate), (Bionolle® 1001 from Showa High Polymer Company); poly(ethylene succinate); poly(1,4-butylene adipate-co-succinate), (Bionolle® 3001 from the Showa High Polymer Company); and poly(1,4-butylene adipate) as, for example, sold by the Ire Chemical Company under the tradename of EnPol®, the Showa High Polymer Company under the tradename of Bionolle®, the Mitsui Toatsu Company, the Nippon Shokubai Company, the Cheil Synthetics Company, the Eastman Chemical Company, and the Sunkyon Industries Company; poly(amide esters), for example, as sold under the Bak® tradename by the Bayer Company (these materials are believed to include the constituents of adipic acid, 1,4-butanediol, and 6-aminocaproic acid); polycarbonates, for example, such as poly(ethylene carbonate) sold by the PAC Polymers Company; poly(hydroxyalkanoates), such as poly(hydroxybutyrate), poly(hydroxyvalerate)s, and poly(hydroxybutyrate-co-hydroxyvalerate)s, for example, such as sold by the Monsanto Company under the Biopol® tradename; poly(lactide-co-glycolide-co-caprolactone), for example, as sold by the Mitsui Chemicals Company under the grade designations of H100J, S100, and T100, poly(caprolactone), for example, as sold under the Tone® tradename by the Union Carbide Company, the Daicel Chemical Company, and the Solvay Company; poly(lactide), for example, as sold by the Cargill Dow Company under the tradename of EcoPLA®, the Dianippon Company, and the like; and copolymers and mixtures thereof.

In some preferred embodiments of the invention, one or more tougheners are blended with the polyester compositions of the present invention. Tougheners include any material that enhances the durability of a polymer or increases its resistance to impact. Examples of tougheners suitable for use in the present invention include, but are not limited to, high density polyethylene; glycidyl-functional polymers, such as poly(ethylene-co-glycidylmethacrylate), poly(ethylene-co-methyl (meth)acrylate-co-glycidyl acrylate), poly(ethylene-co-n-butyl acrylate-co-glycidyl acrylate); poly((meth)acrylates), such as poly(methyl methacrylate), poly(ethyl methacrylate), and the like; polystyrene, including syndiotactic polystyrene, poly(4-hydroxystyrene), and the like; novalacs; poly(cresols); polyamides; nylon, including nylon 6, nylon 46, nylon 66, nylon 612, and the like; copolymers of ethylene with alkyl (meth)acrylates, such as the Elvaloy® polymers available from E.I. du Pont and Company of Wilmington, Del.; polycarbonates, such as poly(bisphenol A carbonate); polysulfides; and poly(phenylene sulfide).

In addition, at least one filler may be added to the polyester compositions of the present invention. Fillers tend to increase the Young's modulus; improve the dead-fold properties; improve the rigidity of the film, coating, laminate, or molded article; decrease costs; and reduce the tendency of the film, coating, or laminate to block or self-adhere during processing or use. The use of fillers has also been found to produce plastic articles having many of the same qualities as paper, such as, for example, texture and feel, as disclosed by, for example, Miyazaki, et. al., in U.S. Pat. No. 4,578,296.

Fillers suitable for use in the present invention include, but are not limited to, inorganic, organic and clay fillers. Such fillers include, but are not limited to, for example, wood flour; gypsum; talc; mica; carbon black; wollastonite; montmorillonite minerals; chalk; diatomaceous earth; sand; gravel; crushed rock; bauxite; limestone; sandstone; aerogels; xerogels; microspheres; porous ceramic spheres; gypsum dihydrate; calcium aluminate; magnesium carbonate; ceramic materials; pozzolamic materials; zirconium compounds; xonotlite

(a crystalline calcium silicate gel); perlite; vermiculite; hydrated or unhydrated hydraulic cement particles; pumice; perlite; zeolites; kaolin; clay fillers, including both natural and synthetic clays and treated and untreated clays, such as organoclays and clays that have been surface treated with silanes and stearic acid to enhance adhesion with the polyester matrix; smectite clays; magnesium aluminum silicate; bentonite clays; hectorite clays; silicon oxide; calcium terephthalate; aluminum oxide; titanium dioxide; iron oxides; calcium phosphate; barium sulfate; sodium carbonate; magnesium sulfate; aluminum sulfate; magnesium carbonate; barium carbonate; calcium oxide; magnesium oxide; aluminum hydroxide; calcium sulfate; barium sulfate; lithium fluoride; polymer particles; powdered metals; pulp powder; cellulose; starch; chemically modified starch; thermoplastic starch; lignin powder; wheat; chitin; chitosan; keratin; gluten; nut shell flour; corn cob flour; calcium carbonate; calcium hydroxide; glass beads; hollow glass beads; seagel; cork; seeds; gelatins; wood flour; saw dust; agar-based materials; reinforcing agents, such as glass fiber; natural fibers, such as sisal, hemp, cotton, wool, wood, flax, abaca, sisal, ramie, bagasse, and cellulose fibers; carbon fibers; graphite fibers; silica fibers; ceramic fibers; metal fibers; stainless steel fibers; and recycled paper fibers, for example, from repulping operations, and the like. Preferably, titanium dioxide is used as the filler, but essentially any filler material known in the art may find use in the polyester compositions of the present invention.

At least one process for preparing the polyester composition of the invention includes providing the microfiber slurry; providing either the slurry, or powder form of the micropowders; contacting the microfiber slurry and either the powder, or the slurry form of the micropowder with at least one polymerizable component of the polyester, such as, for example, the monomers; and polymerizing the polymerizable components. Another process of the invention includes providing the slurry containing both microfibers and micropowders; contacting the slurry with at least one polymerizable component of the polyester, such as, for example, a monomer; and polymerizing the polymerizable components.

Yet another process includes ester exchange of dimethyl terephthalate or other suitable ester precursor and ethylene glycol or other suitable glycol, preferably in the presence of an exchange catalyst. Exemplary exchange catalysts include manganese acetate tetrahydrate, zinc acetate dihydrate, and the like.

For example, the polyester composition of the present invention can be formed by contacting either the microfiber slurry and micropowder slurry or powder, or the slurry containing both microfiber and micropowder with dimethyl terephthalate and ethylene glycol, and allowing ester exchange followed by polycondensation to proceed accordingly. As a further example, the polyester composition of the present invention can be formed by contacting either the microfiber slurry and micropowder slurry or powder, or the slurry containing both microfiber and micropowder with the product of an ester exchange reaction, such as bis(2-hydroxyethyl)terephthalate, which is followed by polycondensation of the monomers at appropriately high temperatures and low pressures and polymerization of the monomers. Another exemplary process for preparing a polyester composition containing microfibers and micropowders includes polyesterification followed by polycondensation.

Such processes are preferably carried out in the presence of polycondensation catalysts, such as antimony or titania-based polycondensation catalysts. For example, either the microfiber slurry and micropowder slurry or powder, or the slurry containing both microfiber and micropowder can be introduced to the polyester after an ester exchange reaction but before polycondensation.

Preferably, the amount of microfibers contained in the resulting polyester composition range from about 0.01 to about 15 wt. %, based on total weight of the polyester composition, more preferably from about 0.1 to about 2.5 wt. %, and most preferably from about 0.2 to about 1 wt. %.

Preferably, the amounts of micropowder contained in the resulting polyester composition range from about 1 to about 30 wt. %, based on total weight of the polyester composition, preferably from about 2 to about 20 wt. %, and most preferably from about 5 to about 20 wt. %.

When a slurry containing both microfiber and micropowder is used, the resulting polyester composition contains from about 0.01 to about 15 wt. % microfiber and from about 0.5 to about 50 wt. % micropowder, based on total weight of the composition, preferably from about 0.1 to about 2.5 wt. % microfiber and from about 1 to 25 wt. % micropowder, and most preferably from about 0.2 to about 1 wt. % microfiber and about 2 to about 15 wt. % micropowder.

The processes of the invention may further include the step of blending the polyester composition with at least one blendable polymeric material. At least one of the blendable polymeric materials may also function as a toughener.

The polymeric material to be blended with the polyester composition of the present invention may be added at any stage either during polymerization, or after polymerization is completed. For example, the polymeric material may be added with the polyester monomers at the start of the polymerization process. Alternatively, the polymeric material may be added at an intermediate stage of the polymerization, for example, as the precondensate passes into the polymerization vessel. As yet a further alternative, the polymeric material may be added after the polyester exits the polymerizer. For example, the polyester and the polymeric material may be melt fed to any intensive mixing operation, such as either a static mixer, or a single- or twin-screw extruder, and compounded with the polymeric material.

In yet a further alternative, the polyester may be combined with the polymeric material in a subsequent post polymerization process. Typically, such a process would involve intensive mixing of the molten polyester with the polymeric material. This intensive mixing can be provided by, for example, a static mixer, Brabender mixer, single screw extruder, or twin screw extruder. In a typical process, the polyester and polymeric material are dried. The polyester can then be mixed with the polymeric material, or in the alternative, the polyester and the polymeric material can be co-fed through two different feeders.

In an extrusion process, the polyester and the polymeric material can typically be fed into the back feed section of the extruder. However, this should not be considered limiting as the polyester and polymeric material can also be advantageously fed into two different sections of the extruder. For example, the polyester can be fed into the back feed section of the extruder, while the polymeric material is fed (or “side-stuffed”) into the front section of the extruder near the die plate. The extruder temperature profile is set up to allow the polyester to melt under the processing conditions. The screw design can also provide stress and, in turn, heat, to the resin as it mixes the molten polyester with the polymeric material.

Alternatively, the polymeric material can be blended with the polyester material during the formation of the films and coatings of the present invention, as is further described in the extrusion process set forth hereinbelow.

In the processes of the present invention, at least one filler can also be added to the polyester composition. The filler can be added to the polyester composition at any stage either during polymerization of the polymer, or after polymerization is completed.

For example, the filler can be added with the polyester monomers at the start of the polymerization process. Preferably, fillers, such as, for example, silica and titanium dioxide are added at the start of polymerization to enable the fillers to be adequately dispersed within the polyester matrix. Alternatively, the fillers can be added at an intermediate stage of polymerization, for example, as the precondensate passes into the polymerization vessel. As yet a further alternative, the filler can be added after the polyester exits the polymerizer. For example, the polyester composition produced by the processes of the present invention can be melt fed to an intensive mixing operation, such as a static mixer or a single- or twin-screw extruder, and compounded with the filler.

As yet a further method to produce the filler containing polyester compositions of the present invention, the polyester composition may be combined with the filler in a subsequent post polymerization process. Typically, such a process involves intensive mixing of the molten polyester with the filler. The intensive mixing can be provided by, for example, a static mixer, Brabender mixer, single screw extruder, or twin screw extruder. In a typical process, the polyester is dried. The polyester can be mixed with the filler, or in the alternative the polyester and the filler can be co-fed through two different feeders.

In an extrusion process, the polyester and the filler can typically be fed into the back feed section of the extruder. However, this should not be considered limiting as the polyester and filler can also be advantageously fed into two different sections of the extruder. For example, the polyester can be fed into the back feed section of the extruder, while the filler is fed (or “side-stuffed”) into the front section of the extruder near the die plate. The extruder temperature profile is set up to allow the polyester to melt under the processing conditions. The screw design can also provide stress and, in turn, heat, to the resin as it mixes the molten polyester with the filler. Acceptable processes for melt mixing fillers are disclosed, for example, in U.S. Pat. No. 6,359,050 to Dohrer et al.

Alternatively, the filler can be blended with the polyester during the formation of the films and coatings of the present invention, as is further described in the extrusion process already set forth herein.

Polyester compositions containing microfibers and micropowders, as disclosed herein, can be used in making a variety of finished articles. Generally, polyesters compositions containing microfibers and micropowders in accordance with the present invention can be used in making any finished article for which polyesters are useful. In general, articles made from the polyesters of the present invention have a desirable balance of physical properties and abrasion resistance. Such articles are therefore recognized as having a wide variety of end uses.

The polyester compositions of the present invention can also be used to make monofilaments via known processes such as, for example, melt spinning. The polyester monofilaments of the present invention are useful in making fabrics that can be used, for example, in making industrial belts.

The polyester compositions of the present invention are also useful in making molded parts. Molded parts of the present invention can be made using any process known for making such molded parts.

The polyester compositions of the present invention are also useful in making films, such as, for example, cast films, blown films, and oriented films. Films made from polyesters containing microfibers and micropowders have been found to have unique surface characteristics. In particular, the presence of the microfibers increases the roughness of the surface of the film, which may be desirable for some applications.

At least one exemplary process for making a film containing microfibers and micropowders in accordance with the present invention is as follows. A 1½″ Davis portable extruder with a 14″ flat sheet die and a chilled casting drum is used to produce a 2 mil cast film. The 1½″ Davis extruder is a 24/1 L/D extruder with four barrel zones that are automatically cooled in case of temperature override. Cooling is done by a closed loop water system. A barrier screw with a mixing tip is used. The 2 mil film is produced using a die gap of 5 mils. The polyester composition containing the microfibers and micropowder is dried prior to extrusion for >12 hours at about 107° C. (225° F.) in a desiccated oven.

The following exemplary processing conditions can be used in preparing such a film:

| | | Barrel and | Head | Chillroll | | Take Off |
|---|---|---|---|---|---|---|
| RPM | Feed Zones | Die Zones | Pressure (psi) | Temp. | Melt Temp. | (in/min) |
| 77 | 209° C. (480° F.) | 260° C. (500° F.) | 610 | 32° C. (90° F.) | 275° C. (527° F.) | 169 |

### EXAMPLES

The present invention is further defined in the following Examples. It should be understood that these Examples are given by way of illustration only. From the above discussions and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth hereinbelow, but rather is defined by the claims contained hereinbelow.

### Example 1

A nominal 4000 lb vertical autoclave with an agitator, vacuum jets and a monomer distillation still located above the clave portion of the autoclave is used to prepare several batches of polymer containing milled Kevlar® (poly(p-phenyleneterephtalamide) available from DuPont Wilmington, Del.) microfiber and Zonyl MP-1600 (finely divided PTFE micropowders available from DuPont, Wilmington, Del.).

The monomer distillation still is charged with approximately 1500 liters (approximately 3800 lbs) of dimethyl terephthalate (DMT) and approximately 650 liters of ethylene glycol. In addition, approximately 420 lbs of a 1% Kevlar® slurry (1% fiber in ethylene glycol) and approximately 1400 lbs of a 14% Zonyl® MP-1600N slurry (14% PTFE micropowder in ethylene glycol) are added to the still. Finally, manganese acetate as a solution in ethylene glycol is added as the ester exchange catalyst, and antimony trioxide as a solution in ethylene glycol is added as the polycondensation catalyst. The temperature of the still is raised to approximately 250° C. over a period of about 180 minutes. Atmospheric pressure is maintained in the still during the ester exchange reaction. An estimated 1300 lbs (approximately 700 liters) of methanol distillate is recovered. The molten monomer, bis(2-hydroxyethyl terephthalate), that is produced is then dropped from the monomer distillation still to the clave portion of the autoclave.

The ingredients are mixed, agitated, and polymerized by increasing the temperature to a final polymerization temperature of approximately 295° C. The pressure is reduced to a final pressure of about 1 mm Hg over a period of about 180 minutes. The resulting polymer is extruded through a 33 hole casting plate into strands, which are then quenched, cut, and boxed.

The resulting polymer is tested and found via the solution method to have an intrinsic viscosity (IV) of about 0.58 (Goodyear method). The resulting polymer is further found via Differential Scanning Calorimetry (DSC) methods to have a crystallization temperature of about 125° C. and a melt temperature of about 258° C.

### Example 2

The polymer produced in example 1 is then solid phase polymerized. First, the polymer of example 1 is characterized and found via the solution method to have an IV of about 0.58 (Goodyear method). Next, about 300 lbs of the example 1 polymer is put into a horizontal tumble reactor. The temperature is increased from 25° C. to 135° C. over 220 minutes, and the flake is held at 135° C. for 220 minutes to effect crystallization. The temperature is subsequently raised over about 180 minutes to 237° C. The material is held at temperature for about 850 minutes, cooled, and packed out. The final polymer is tested and found via the solution method to have an IV of about 0.72.

### Examples 3-7

A nominal 100 lb autoclave with an agitator, vacuum and a monomer distillation still located above the clave portion of the autoclave is used to prepare several batches of polymer containing milled Kevlar® microfiber and Zonyl® MP-1600N (PTFE) micropowder. The compositions of the resulting Example 3-7 polymers are set forth in Table A.

In preparing the Example 3-7 polymers, the DMT along with 65 lbs of ethylene glycol are charged to the still. Next, the 1% slurry of Kevlar® (1% fiber in ethylene glycol) microfiber and the Zonyl® MP-1600N micropowder are added to the still. The Zonyl® MP-1600N is added to the still in powder form. Finally, manganese acetate as a solution in ethylene glycol is added as the ester exchange catalyst, and antimony trioxide as a solution in ethylene glycol is added as the polycondensation catalyst.

The temperature of the still is raised to about 240° C. and approximately 15 liters of methanol distillate is recovered. The molten monomer, bis(2-hydroxyethyl terephthalate), that is produced is then dropped from the monomer distillation still to the clave portion of the autoclave.

All of the ingredients are mixed, agitated and polymerized by increasing the temperature to a final polymerization temperature of about 285° C. The pressure is reduced to a final pressure of about 1 mm Hg. The polymer is extruded through a 33 hole casting plate into strands, which are quenched, cut and boxed. The polymers are crystallized and solid state polymerized in a horizontal tumble reactor. The polymers are crystallized at 135° C. and solid state polymerized at about 237° C. for a total heating time of 24 hrs.

The peak crystallization and melting point temperatures set forth in Table A for each of the Example 3-7 polymers were determined via the DSC method. The Electron Spectroscopy for Chemical Analysis (ESCA) of each of the Example 3-7 polymer compositions as set forth in Table A is determined by analyzing the surface of each polymer. These results confirm that the fluoropolymer is contained in the polymer samples, wherein the “F atom %” quantifies the percentage of fluorine atoms observed, and the “F/C ratio” quantifies the ratio of fluorine to carbon atoms observed in the sample.

TABLE A

| | | | | | lbs | | DSC Peak | | |
|---|---|---|---|---|---|---|---|---|---|
| | | % | | lbs 1% | Zonyl ®-MP | DSC Peak | Melting | ESCA | |
| | % | Zonyl ®-MP | lbs | Kevlar ® | 1600N | Crystallization | Point | F atom | |
| Example | Kevlar ® | 1600N | DMT | Slurry | powder | Temp. ° C. | Temp. ° C. | % | F/C Ratio |
| 3 | 0.1 | 1 | 99 | 10 | 1 | 185 | 245 | 0.9 | 0.010 |
| 4 | 0.1 | 5 | 95 | 10 | 5 | 184 | 241 | 3.2 | 0.041 |
| 5 | 0.1 | 10 | 90 | 10 | 10 | 188 | 245 | 18 | 0.270 |
| 6 | 0.2 | 5 | 95 | 20 | 5 | 184 | 248 | 3.4 | 0.041 |
| 7 | 0 | 5 | 100 | 0 | 5 | 186 | 248 | 10 | 0.140 |

### Examples 8-12

The Example 3-7 polymers are melt spun and drawn into monofilament yarns for evaluation of processing and monofilament properties. The processing conditions used are standard polyethylene terphthalate (PET) spinning conditions as shown in Table B. The resulting Example 8-12 monofilament yarn is compared to the yarn obtained from the commercially available Crystar® 5027 (DuPont, Wilmington, Del.) linear PET homopolymer with an IV of 0.72. The properties of the resulting Example 8-12 yarn as compared to Crystar® 5027 linear PET homopolymer are shown below in Table B.

The Example 3-7 and Crystar® 5027 polymers were dried overnight at 120° C., and subsequently spun through a 60-80-60 mesh pack screen at the conditions shown in Table B to form a round extrudate. The fibers were mechanically drawn in multiple stages with heat applied at constant tension between draw modules.

Table B evidences the surprising effects that the microfiber and micropowder containing monofilaments were found to have on the physical properties of a monofilament containing such high loadings of fluoropolymer micropowder in comparison to a Crystar® 5027 (a linear PET homopolymer) monofilament that did not contain any micropowder or microfiber. That is, the high loadings of fluoropolymer micropowder were surprisingly found to produce monofilaments having the same or similar properties to a Crystar® 5027 (a linear PET homopolymer) monofilament that did not contain any micropowder or microfiber.

TABLE B

| MATERIALS | | | | | | | | | |
|---|---|---|---|---|---|---|---|---|---|
| | Example No. | SPINNING CONDITIONS | | | | | | | |
| | of Polymer | Die | | Screw | MONOFILAMENT FIBER PROPERTIES | | | | |
| | Composition | Pressure | Torque | Speed | Draw | Fiber | Tenacity | Elongation | Modulus |
| | Tested | (psi) | (Mg) | (rpm) | Ratio | Denier | (g/d) | (%) | (gpd) |
| Example 8 | 3 | 440 | 4700 | 13 | 4.56 | 2480 | 3.9 | 28 | 85 |
| | 3 | 440 | 4700 | 13 | 5.59 | 2060 | 6 | 16 | 94 |
| Example 9 | 4 | 510 | 4300 | — | 4.56 | 2595 | 3.8 | 23 | 82 |
| | 4 | 510 | 4300 | — | 5.59 | 2084 | 5.9 | 16 | 92 |
| Example 10 | 5 | 500 | 3300 | 14 | 4.56 | 2694 | 3.3 | 25 | 73 |
| | 5 | 500 | 3300 | 14 | 5.59 | 2210 | 4.8 | 15 | 83 |
| Example 11 | 6 | 430 | 5000 | 13 | 4.56 | 2544 | 3.3 | 26 | 83 |
| Example 12 | 7 | 510 | 5000 | 13 | 4.56 | 2607 | 3.7 | 25 | 79 |
| | 7 | 510 | 5000 | 13 | 5.59 | 2155 | 5.5 | 16 | 90 |
| Crystar ® | — | 370 | 1600 | 21 | 4.56 | — | 3.7 | 23 | 94 |
| 5027¹ | | | | | | | | | |

¹Crystar ® 5027 is a linear PET homopolymer manufactured by E. I. du Pont de Nemours and Company, Inc., Old Hickory, TN.

### Examples 13-18

134.75 g bis(2-hydroxyethyl) terephthalate, 0.0468 g manganese (II) acetate tetrahydrate, and 0.0365 g antimony (III) oxide are added to a 250 ml glass flask. The Table C indicates the amount of microfiber and micropowder that was added to the 250 ml flask. The resulting reaction mixture was then stirred. The reaction mixture was subsequently heated to 180° C. under a slow nitrogen purge and held for about 0.5 hrs. The reaction mixture was then heated to 285° C. and held again for about 0.5 hrs. Finally, the reaction mixture was staged to full vacuum (less than 100 m torr) at 285° C. while being stirred for the period of time shown in Table C. The vacuum was released and the reaction mass was cooled to room temperature.

The laboratory relative viscosity (LRV) and crystalline melt point of each of the Example 13-18 reaction products was obtained and set forth in Table C. The crystalline melt point was obtained by using DSC methods. The Table C data exemplifies the polyester compositions made by various methods using powder or slurry forms of the microfiber and micropowder ingredients.

TABLE C

| | | | Amount and Form of Microfiber | | | | | | |
|---|---|---|---|---|---|---|---|---|---|
| | % Microfiber and | | and Micropowder Added to the | | | | | Properties of Final | |
| | % Micropowder | | Polyester | | | | | Polyester | |
| | in Final Polyester | | | Amount of | Amount | Amount of | Processing | Composition | |
| | Composition | | Amount of | 3% Zonyl ®-MP | Zonyl ®-MP | 1.5% Kevlar ® and | Conditions | | DSC |
| | | % | 1.5% Kevlar ® | 1600N | 1600N | 1.5% Zonyl-MP | Time at Full | | Crystalline |
| | % | Zonyl ®-MP | slurry | Slurry | Powder | 1600N | Vacuum | | Melt Point |
| Example | Kevlar ® | 1600N | (gm) | (gm) | (gm) | Slurry (gm) | (min) | LRV | (° C.) |
| 13 | 0.25 | 0.5 | 17.2 | — | 0.0513 | — | 50 | 20.5 | 254 |
| 14 | 0.25 | 5 | 18.0 | — | 5.4 | — | 88 | 16.3 | 252 |
| 15 | 0.25 | 10 | 18.8 | — | 11.3 | — | 54 | 18.4 | 251 |
| 16 | 0.25 | 0.25 | — | — | — | 17.2 | 47 | 19.1 | 248 |
| 17 | 0.25 | 5 | 18.0 | 180 | — | — | 85 | 22 | 247 |
| 18 | 5 | 5 | — | — | — | 365 | 45 | 7.6 | 251 |

### Example 19

A premix slurry containing micropowder and fiber was prepared by premixing ethylene glycol, 1.5% KEVLAR® pulp 1F543 sold by DuPont, Wilmington, Del. and 1.5% Teflon® PTFE micropowder (Zonyl® 1600N MP sold by DuPont, Wilmington, Del.) with a Cowles blade mixer supplied by Premier Mill, Inc., Reading, Pa. The Cowles blade mixer contained a high speed agitator that operated at a speed ranging from about 100 to about 1000 rpm. The weight percentages were based on the total weight of the slurry.

The premix was subsequently added to a Premier SML media mill (1.5 L Supermill) supplied by Premier Mill, Inc., Reading, Pa. The media mill had a 5 plastic disk set up and a 1.38 liter working capacity. Prior to adding the premix, 1035 ml of 1.0 mm solid ceramic spherical media available under the tradename Mill Mates supplied by Premier Mill, Inc., Reading, Pa. was added to the mill so that the mill contained a 75% load of spherical media.

The particle size of the micropowder for a given mill setup, i.e. mill type, media type, processing speed, etc. was controlled by the residence time of the premix in the milling chamber of the media mill. Residence time is a function of free mill volume, total liquid batch size, and total run time.

After the premix was added to the media mill, the premix and solid media were agitated for 8 hours. The resulting slurry appeared to be stable and was much more viscous than the micropowder slurry of Comparative Example 20. There was no visible separation or settling.

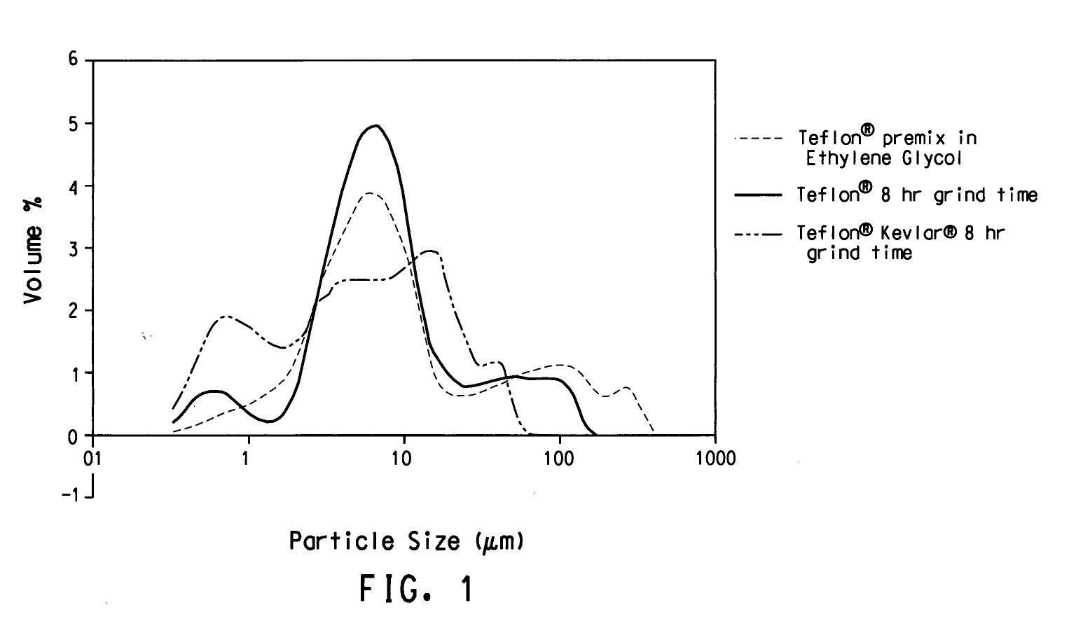

A Beckman Coulter LS200 particle size analyzer supplied by Beckman Coulter, Inc., Fullerton, Calif. was used to measure the size of the micropowder particles contained in the resulting slurry. The mean particle size of the micropowder particles contained in the Teflon® micropowder and Kevlar® microfiber containing slurry are set forth in Table D. A graph depicting the particle size distribution of the micropowder particles contained in the Teflon® micropowder and Kevlar® microfiber containing slurry is set forth in FIG. 1.

It is of import to note that the particle size analyzer could not distinguish between the Kevlar® microfibers and the Teflon® micropowder particles present in the microfiber and micropowder containing slurry. As a result, the largest and smallest micropowder particles could not be specificially identified, but the largest particle was clearly reduced to about 70 microns and possibly to particle sizes even smaller than 70 microns if the 70 micron size particles were actually Kevlar® microfibers. Although the actual size of the largest Teflon® micropowder particles in the slurry could not be determined, the size of the micropowder particles was 70 microns or less, which was considerably smaller than the Comparative Example 20 premix and slurry, which only contained Teflon® micropowder and no Kevlar® fibers/microfibers.

The Teflon® micropowder containing slurry premix had a mean micropowder particle size of 43 microns with the largest measured particle size being >600 microns. After the premix was subjected to 8 hours of grinding, the mean particle size of the micropowder particles was reduced to 17 microns with the largest measured particle size being 194 microns.

After the Teflon® micropowder and Kevlar® microfiber containing slurry premix was subjected to 8 hours of grinding, the slurry contained a mean particle size of 10 microns with the largest measured particle having a size of 70 microns.

The Zonyl® 1600N micropowder used in producing the slurries of Comparative Example 20 and Example 19 had a beginning mean micropowder particle size of 12 microns. The data in Table D indicate that prior to being ground the micropowder contained in the Comparative Example 20 slurry apparently underwent a considerable amount of agglomeration upon being premixed with the ethylene glycol. The data of Table D further indicate that the agglomerated micropowder contained in the Comparative Example 20 slurry premix was reduced by subjecting the slurry premix to 8 hours of grinding. The resulting Comparative Example 20 micropowder slurry, however, still contains particles with a mean particle size of 17 microns and agglomerates as large as 194 microns. Moreover, the micropowders contained in the Comparative Example 20 slurries were observed to readily separate out of the ethylene glycol and settle to the bottom of the container.

The data of Table D further indicate that co-grinding micropowder and fiber in ethylene glycol produced in Example 19 micropowder and microfiber containing slurry had a mean particle size of 10 microns, considerably smaller than the 17 micron and 47 micron mean particle sizes of the Comparative Example 20 slurries.

The Table D data further indicate that the largest measured particle of the Example 19 slurry was 70 microns, whereas the largest measured particles of the Comparative Example 20 slurries were >600 microns and 194 microns. Again, the 70 micron measurement for the largest particle of Example 1 is considerably smaller than >600 micron and 194 micron measurement for the largest particles of Comparative Example 20. Moreover, in contrast to the slurries of Comparative Example 19, the Example 19 slurry was observed to be stable with no apparent particle separation.

Although the particle size analyzer cannot distinguish between the microfibers and micropowder particles, the largest particle was clearly reduced to 70 microns and possibly to particle sizes even smaller than 70 microns if the 70 micron size particles were actually Kevlar® microfibers. In addition, while the actual size of the largest Teflon® micropowder particle cannot be determined for the microfiber and micropowder containing slurry of Example 1, the size of the micropowder particles must be 70 microns or less, which is considerably smaller than the micropowder particles of the Comparative Example 20 slurries, which only contained Teflon® micropowder and no Kevlar® fibers/microfibers.

### Comparative Example 20

A premix slurry containing micropowder was prepared by premixing adding ethylene glycol and 3% Teflon® PTFE micropowder (Zonyl® 1600N MP sold by DuPont, Wilmington, Del.) to with a tank Cowles blade mixer supplied by Premier Mill, Inc., Reading, Pa. The Cowles blade mixer contained a high speed agitator that operated at a speed ranging from about 100 to about 1000 rpm. The weight percentages were based on the total weight of the slurry. A person of ordinary skill in the art knows how to determine the amount of micropowder to add to obtain the desired micropowder weight percentage.

The premix was observed to be very lumpy, not homogeneous at all, and separated out of the ethylene glycol if not agitated. The PTFE micropowder was observed to-settling quickly to the bottom of the container.

The premix was subsequently added to a Premier SML media mill (1.5 L Supermill) supplied by Premier Mill, Inc., Reading, Pa. Prior to adding the premix, however, a sample of the premix was collected to measure the particle sizes of the PTFE micropowder contained in the premix. In addition, 1035 ml of 1.0 mm solid ceramic spherical media available under the tradename Mill Mates supplied by Premier Mill, Inc., Reading, Pa. was added to the media mill before the premix was added. A Beckman Coulter LS200 particle size analyzer supplied by Beckman Coulter, Inc., Fullerton, Calif. was used to analyze the size of the micropowder particles contained in the premix.

The particle size of the micropowder for a given mill setup, i.e. mill type, media type, processing speed, etc. was controlled by the residence time of the premix in the milling chamber of the media mill. Residence time is a function of free mill volume, total liquid batch size, and total run time.

An initial batch size of 8500 grams was run in recirculation for 8 hours. After 8 hours, a second sample was collected to analyze the size of the micropowder particles contained in the resulting slurry. The PTFE micropowder of the resulting slurry was again observed settling to the bottom of the container.

The mean particle size of the micropowder particles contained in the Teflon® micropowder slurry samples is set forth in Table D. A graph depicting the particle size distribution of the micropowder particles contained in the Teflon® micropowder slurry samples is set forth in FIG. 1.

TABLE D

| | | Mean Particle |
|---|---|---|
| Examples | Mixture | Size (microns) |
| Ex. 19 | Teflon ®/Kevlar ® (8 hr grind) | 10 |
| Comp. Ex. 20 | Teflon ® premix (pre-grind) | 43 |
| | Teflon ® (8 hr grind) | 17 |

As all other things, i.e. processing conditions, processing procedures, equipment used, etc. are equal between the Comparative Example 20 Teflon® micropowder containing slurry and the Example 19 Teflon® micropowder and Kevlar® microfiber containing slurry, the Kevlar® fibers are believed to contribute to the smaller micropowder particle sizes of the Example 19 slurry, as well as, the better stability and decreased separation of the dispersed micropowder particles.

What is claimed is:

1. A polyester composition comprising a polyester, from about 0.01 to about 15 wt. % of at least one microfiber, and from about 0.5 to about 50 wt. % of at least one micropowder, based on total weight of the polyester composition.

2. The polyester composition of claim 1, comprising from about 0.1 to about 2.5 wt. % of said at least one microfiber and from about 1 to about 25 wt. % of said at least one micropowder.

3. The polyester composition of claim 1, comprising from about 0.2 to about 1 wt. % of said at least one microfiber and from about 2 to about 15 wt. % of said at least one micropowder.

4. The polyester composition of claim 1, wherein said polyester comprises polyethylene terephthalate.

5. The polyester composition of claim 4, wherein said polyester is a polyethylene terephthalate homopolymer.

6. The polyester composition of claim 4, wherein said polyester is a polyethylene terephthalate copolymer.

7. The polyester composition of claim 1, wherein said at least one microfiber comprises organic microfibers.

8. The polyester composition of claim 7, wherein said at least one organic microfiber comprises a polymeric material selected from aliphatic polyamides, polyesters, polyacrylonitriles, polyvinyl alcohols, polyolefins, polyvinyl chlorides, polyvinylidene chlorides, polyurethanes, polyfluorocarbons, phenolics, polybenzimidazoles, polyphenylenetriazoles, polyphenylene sulfides, polyoxadiazoles, polyimides, aromatic polyamides, cellulose, cotton, silk, wool, and mixtures thereof.

9. The polyester composition of claim 1, wherein said at least one microfiber comprises inorganic microfibers.

10. The polyester composition of claim 9, wherein said inorganic microfibers comprise a material selected from alumina, silica, glass, carbon, boron, boron carbide, silicon carbide, and mixtures thereof.

11. The polyester composition of claim 1, wherein said at least one micropowder comprises a material selected from PTFE, PTFE homopolymers, PTFE copolymers, organic polymers, pulverized minerals, and mixtures thereof.

12. The polyester composition of claim 1, further comprising at least one filler.

13. The polyester composition of claim 12, wherein the at least one filler comprises titanium dioxide.

14. The polyester composition of claim 1, further comprising at least one toughener.

15. A process for making a polyester composition comprising a polyester, at least one microfiber, and at least one micropowder, said process comprising providing said at least one microfiber in a form selected from a slurry, providing said micropowder in a form selected from a powder and a slurry, contacting said microfiber and said micropowder with at least one polymerizable component of the polyester, and polymerizing the polymerizable components.

16. The process of claim 15, wherein the amount of the at least one microfiber in said slurry is from about 0.01 to about 50 wt. %, based on total weight of the slurry.

17. The process of claim 16, wherein the amount of the at least one micropowder in said slurry is from about 0.5 to about 50 wt. %, based on total weight of the slurry.

18. The process of claim 16, wherein the amount of the at least one micropowder in said powder form is from about 0.5 to about 50 wt. %, based on total weight of the polyester composition.

19. The process of claim 15, wherein the amount of the at least one microfiber in said slurry is from about 0.1 to about 15 wt. %, based on total weight of the slurry.

20. The process of claim 15, wherein the amount of the at least one microfiber in said slurry is from about 0.1 to about 10 wt. %, based on total weight of the slurry.

21. The process of claim 15, wherein the amount of the at least one microfiber in said slurry is from about 0.1 to about 5 wt. %, based on total weight of the slurry.

22. The process of claim 15, wherein the amount of the at least one microfiber in said slurry is from about 0.1 to about 2.5 wt. %, based on total weight of the slurry.

23. The process of claim 22, wherein the amount of the at least one micropowder in said powder form is from about 1 to about 25 wt. %, based on total weight of the polyester composition.

24. The process of claim 15, wherein the amount of the at least one microfiber in said slurry is from about 0.2 to about 1 wt. %, based on total weight of the slurry.

25. The process of claim 24, wherein the amount of the at least one micropowder in said powder form is from about 2 to about 15 wt. %, based on total weight of the polyester composition.

26. The process of claim 15, wherein the amount of the at least one micropowder in said powder form is from about 0.5 to about 50 wt. %, based on total weight of the polyester composition.

27. The process of claim 15, wherein the amount of the at least one micropowder in said powder form is from about 1 to about 25 wt. %, based on total weight of the polyester composition.

28. The process of claim 15, wherein the amount of the at least one micropowder in said powder form is from about 2 to about 15 wt. %, based on total weight of the polyester composition.

29. The process of claim 15, wherein the amount of the at least one micropowder in said slurry is from about 0.5 to about 50 wt. %, based on total weight of the slurry.

30. The process of claim 15, wherein the amount of the at least one micropowder in said slurry is from about 1 to about 25 wt. %, based on total weight of the slurry.

31. The process of claim 15, wherein the amount of the at least one micropowder in said slurry is from about 1 to about 20 wt. %, based on total weight of the slurry.

32. The process of claim 15, wherein the amount of the at least one micropowder in said slurry is from about 1 to about 10 wt. %, based on total weight of the slurry.

33. The process of claim 15, wherein said microfiber slurry comprises organic microfibers.

34. The process of claim 33, wherein said organic microfibers comprise a polymeric material selected from aliphatic polyamides, polyesters, polyacrylonitriles, polyvinyl alcohols, polyolefins, polyvinyl chlorides, polyvinylidene chlorides, polyurethanes, polyfluorocarbons, phenolics, polybenzimidazoles, polyphenylenetriazoles, polyphenylene sulfides, polyoxadiazoles, polyimides, aromatic polyamides, cellulose, cotton, silk, wool, and mixtures thereof.

35. The process of claim 15, wherein said slurry comprises inorganic microfibers.

36. The process of claim 35, wherein said inorganic microfibers comprise a material selected from alumina, silica, glass, carbon, boron, boron carbide, silicon carbide, and mixtures thereof.

37. The process of claim 15, wherein said at least one micropowder comprises a material selected from PTFE, PTFE homopolymers, PTFE copolymers, organic polymers, pulverized minerals, and mixtures thereof.

38. The process of claim 15, further comprising adding at least one filler to the polyester composition.

39. The process of claim 38, wherein the at least one filler comprises titanium dioxide.

40. The process of claim 15, further comprising blending the polyester composition with at least one toughener.

41. A process for making a polyester composition comprising a polyester, at least one microfiber, and at least one micropowder, said process comprising providing a slurry containing the at least one microfiber and the at least one micropowder, contacting the slurry with at least one polymerizable component of the polyester, and polymerizing the polymerizable components.

42. The process of claim 41, wherein the slurry contains from about 0.01 wt. % to about 15 wt. % microfiber and from about 0.5 to about 50 wt. % micropowder, based on total weight of the slurry.

43. The process of claim 41, wherein the slurry contains from about 0.2 wt. % to about 15 wt. % microfiber and from about 2 to about 30 wt. % micropowder, based on total weight of the slurry.

44. The process of claim 41, wherein the slurry contains from about 0.2 wt. % to about 10 wt. % microfiber and from about 2 to about 25 wt. % micropowder, based on total weight of the slurry.

45. The process of claim 41, wherein the slurry contains from about 0.2 wt. % to about 5 wt. % microfiber and from about 2 to about 20 wt. % micropowder, based on total weight of the slurry.

46. The process of claim 41, wherein the slurry contains from about 0.2 wt. % to about 2.5 wt. % microfiber and from about 5 to about 20 wt. % micropowder, based on total weight of the slurry.

47. A slurry comprising at least one micropowder, at least one microfiber and a liquid medium.

48. The slurry of claim 47, wherein said liquid medium is selected from aqueous solvents; non-aqueous solvents; monomers; and polymer precursors.

49. The slurry of claim 47, wherein the slurry contains from about 0.01 wt. % to about 15 wt. % microfiber and from about 0.5 to about 50 wt. % micropowder, based on total weight of the slurry.

50. The slurry of claim 47, wherein the slurry contains from about 0.2 wt. % to about 15 wt. % microfiber and from about 2 to about 30 wt. % micropowder, based on total weight of the slurry.

51. The slurry of claim 47, wherein the slurry contains from about 0.2 wt. % to about 10 wt. % microfiber and from about 2 to about 25 wt. % micropowder, based on total weight of the slurry.

52. The slurry of claim 47, wherein the slurry contains from about 0.2 wt. % to about 5 wt. % microfiber and from about 2 to about 20 wt. % micropowder, based on total weight of the slurry.

53. The slurry of claim 47, wherein the slurry contains from about 0.2 wt. % to about 2.5 wt. % microfiber and from about 5 to about 20 wt. % micropowder, based on total weight of the slurry.

54. A process for producing a slurry comprising at least one microfiber, at least one micropowder and a liquid medium, wherein said process comprises: providing a starting material and at least one micropowder; providing at least one liquid medium and a solid component; contacting the starting material and the at least one micropowder with the liquid medium and the solid component; agitating the starting material, the at least one micropowder, the liquid medium and the solid component for an effective amount of time to produce a slurry containing at least one microfiber and the at least one micropowder; and optionally removing the solid component.

55. The process according to claim 54, wherein the at least one microfiber has a volume average length of about 0.01 to about 100 microns.

56. The process according to claim 54, wherein the at least one microfiber has a diameter of about 8 to 12 microns.

57. The process according to claim 54, wherein the at least one micropowder has an average diameter of 0.01 to 100 microns.

58. The process according to claim 54, wherein the at least one micropowder has an average diameter of about 5 microns or less.

59. The process according to claim 54, wherein the slurry contains about 0.01 to about 15 wt. % of the at least one microfiber and about 0.5 to about 50 wt. % of the at least one micropowder, based on total weight of the slurry.

60. The process according to claim 54, wherein the slurry contains from about 0.2 to about 15 wt. % of the at least one microfiber and from about 2 to about 30 wt. % of the at least one micropowder, based on total weight of the slurry.

61. The process according to claim 54, wherein the slurry contains from about 0.2 to about 10 wt. % of the at least one microfiber and from about 2 to about 25 wt. % of the at least one micropowder, based on total weight of the slurry.

62. The process according to claim 54, wherein the slurry contains from about 0.2 to about 5 wt. % of the at least one microfiber and from about 2 to about 20 wt. % of the at least one micropowder, based on total weight of the slurry.

63. The process according to claim 54, wherein the slurry contains from about 0.2 to about 2.5 wt. % of the at least one microfiber and from about 5 to about 20 wt. % of the at least one micropowder, based on total weight of the slurry.

64. A molded article comprising the polyester composition of claim 1.

65. A monofilament comprising the polyester composition of claim 1.

66. A film comprising the polyester composition of claim 1.
